(19) United States
(12) Patent Application Publication
(10) Pub. No.: US 2005/0269374 A1
(43) Pub. Date: Dec. 8, 2005

(54) Microdosing device

(76) Inventors: Joachim Koerner, Uhldingen (DE); Michael Helmlinger, Radolfzell (DE); Holger Schuerle, Radolfzell (DE)

Correspondence Address: FLYNN THIEL BOUTELL & TANIS, P.C., 2026 RAMBLING ROAD, KALAMAZOO, MI, 49008-1631, US

(21) Appl. No.: 11/051,962

(22) Filed: Feb. 4, 2005

(30) Foreign Application Priority Data
Feb. 5, 2004 (DE) 102004006451.2

(51) Int. Cl. B67D 3/00; B67D 5/06

(52) U.S. Cl. 222/504

(57) ABSTRACT

1. Microdosing device. 2.1 A microdosing device for a medium is known, with an energy store for electrical energy, a medium reservoir, and a dosing chamber which at least temporarily receives a quantity of liquid and to which at least one dispensing opening and one vibration unit are assigned, said vibration unit being operatively connected at least to one boundary surface of the dosing chamber in order to cause this boundary surface to oscillate for the purpose of a dispensing operation. 2.2 According to the invention, a quantity of energy stored in the energy store and an energy demand required to dispense a quantity of medium stored in the medium reservoir correspond at least almost to one another. 2.3 Use for dosing of medium. 3. Single FIGURE

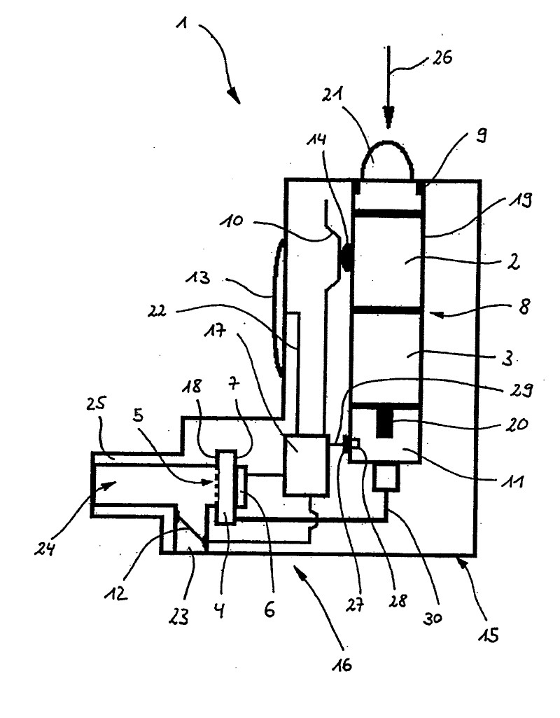

The invention relates to a microdosing device for a medium, with an energy store for electrical energy, a medium reservoir, and a dosing chamber which at least temporarily receives a quantity of liquid and to which at least one dispensing opening and one vibration unit are assigned, said vibration unit being operatively connected at least to one boundary surface of the dosing chamber in order to cause this boundary surface to oscillate for the purpose of a dispensing operation.

Many different designs of microdosing devices of this kind are known from the prior art. They are used for dispensing liquids and serve to administer cosmetic or pharmaceutical products to users. Microdosing devices of the generic type have a medium reservoir for receiving the liquid to be dispensed, and a dosing chamber connected to the medium reservoir. The dosing chamber can be caused to oscillate by a vibration unit, causing pressure waves to act on a liquid stored in the dosing chamber. For this purpose, the vibration unit is supplied with electrical energy taken from an energy store of the microdosing device. By means of the pressure waves, the liquid overcomes a flow resistance and can be dispensed through at least one dispensing opening of the dosing chamber into an environment of the microdosing device.

The object of the invention is to make available a microdosing device of the type mentioned at the outset which can operate economically by simple means.

This object is achieved by the fact that a quantity of energy stored in the energy store and an energy demand required to dispense a quantity of medium stored in the medium reservoir correspond at least almost to one another. An energy store can in particular be designed as a battery, capacitor, solar cell, fuel cell or accumulator, or as a combination of these. In the energy store, a quantity of energy is stored which can be called on for a dispensing operation, in particular for powering the vibration unit and a control unit optionally arranged upstream. This quantity of energy corresponds, at least almost, to an energy demand for delivering and dispensing the medium stored in the medium reservoir. The energy demand is determined in particular by the vibration unit and by the control unit. With the solution according to the invention, it is ensured that the quantity of medium in the medium reservoir and the energy in the energy store run down in unison and, accordingly, can be jointly replaced or can be removed from the microdosing device in a common procedure. By making the stored quantity of energy correspond to the energy demand, it is possible to achieve a particularly expedient adaptation of the energy store to the quantity of medium, or, conversely, of the quantity of medium to the energy store. In this way, it is possible to avoid the energy store or medium reservoir having too great or too small a dimension. In adapting the quantity of energy and the energy demand, it must be taken into account that a loss of energy could arise through running-down or ageing of the energy store or through other external factors and, accordingly, there would be a certain overcapacity of the quantity of energy stored in the energy store in relation to the energy demand. The quantity of energy and the energy demand do not therefore have to correspond entirely. In this way, it is possible to ensure reliable dispensing of the entire quantity of medium from the medium reservoir.

In one embodiment of the invention, the energy store and the medium reservoir are combined in one separate disposable unit. In this way it can be ensured that the energy store adapted to the quantity of medium is also actually emptied substantially proportionally to the dispensing of medium and in this way the desired relationship between the stored quantity of energy and the energy demand is maintained. For combining the energy store and the medium reservoir in the disposable unit, a parent structural unit in the sense of a common housing can be provided. Conventional medium reservoirs and energy stores are then built into this common housing and in this way joined together to form the disposable unit. In one embodiment, the energy store and the medium reservoir are connected fixedly to one another as integral components of the disposable unit. In another particularly preferred embodiment, the disposable unit is connected in a releasable manner to a housing of the microdosing device. An electromechanical interface with locking means and contact means is advantageously provided for coupling and uncoupling of the disposable unit. The locking means provided can be, in particular, locking means acting with a form fit, material fit and/or force fit, such as locking lugs, undercuts, guide tracks or magnet elements. The contacting means used for transmitting electrical signals can be, in particular, contact surfaces and corresponding contact tongues or contact springs. The electromechanical interface permits a secure, engageable and disengageable connection of the disposable unit to the microdosing device. In this way, at the same time as the disposable unit is mechanically fitted onto the microdosing device, electrical contact can also be established between microdosing device and disposable unit.

In a further embodiment of the invention, a dosing pump to be actuated manually is provided on the medium reservoir. A dosing pump to be actuated manually can be designed in particular as a piston pump, diaphragm pump or droplet dispenser pump and is preferably embodied as a pump system for a medium that is free from preserving agent. With the dosing pump, the medium stored in the medium reservoir is transported to the dosing chamber. By using a dosing pump that is to be actuated manually, it is possible to use a dosing pump which can be produced on a large scale and therefore particularly cost-effectively and which requires only minor adjustment to the microdosing device. To actuate the dosing pump, a manoeuvring means, in particular designed as a slide or push button, is provided on the microdosing device. With this manoeuvring means, the user can exert a force on the dosing pump, as a result of which a defined quantity of medium is introduced into the dosing chamber. The dispensing of the medium can take place dependently or independently of the force applied by the user.

In a further embodiment of the invention, a mechanical and/or electrical dose-triggering means is provided to synchronize the dosing with a respiratory movement on the part of a user. When the microdosing device is used to dispense pharmaceutical or medical products in particular, especially by inhalation into the user's respiratory tract, dose-triggering is advantageous. By means of this dose-triggering, a quantity of medium to be dispensed from the microdosing device can be dispensed exactly when a respiratory movement on the part of a user is established by the dose-triggering means. In this way, proper inhalation of the medium dispensed from the microdosing device by the user can be guaranteed. A mechanical and/or electrical dose-triggering can be realized in particular by the dose being triggered in a manner dependent on the volumetric flow. As volumetric flow, a quantity of air per unit of time is determined which is sucked through the microdosing device, in particular by inhalation on the part of the user. To determine the volumetric flow, mechanical flap valves on the microdosing device can be triggered by a suction flow produced during the inhalation movement. Alternatively, or in addition to this, an electrical and/or electronic volumetric flow measurement can be provided, in particular by capacitive, resistive or inductive volumetric flow measurement. As soon as a limit value for the stream of air is reached, the dose-triggering means triggers, mechanically, electromechanically or electronically, the dosing of the medium. In this way, the desired synchronization between the respiratory movement of the user and the dosing is achieved.

In a further embodiment of the invention, a mechanical and/or electronic dosing-locking means is provided to ensure correct dosing of the medium. A dosing-locking means can have the effect that use of the microdosing device by unauthorized users is prevented. Moreover, by integration of a timer into the dosing-locking means, a time control of successive dosing operations can be permitted. A dosing-locking means can also come into effect in case of excessive ageing of the medium to be dispensed and can prevent use of the microdosing device after a shelf-life has expired. The mechanical and/or electronic dosing-locking means can act in particular on the manually actuated dosing pump and/or on the vibration unit.

In a further embodiment of the invention, a counting and/or display device is provided for documenting the dispensed doses of medium. A counting and/or display device can be mechanical, electrical, electronic or a combination of these. By means of a counting device, a number of effected medium-dosing operations can be recorded and stored. For documentation purposes, the stored number of medium-dosing operations can either be read out from the memory of the counting device or can be made directly available to the user via a display device. The counting device can be designed as an upward counter with a numerical value increasing at each medium-dosing operation. However, it can also be designed as a downward counter, with a numerical value being reduced at each medium-dispensing operation. In the case of a downward counter in particular, it is easy to indicate a number of residual medium-dosing operations stored in the microdosing device.

In a further embodiment of the invention, synchronization means are provided for timed vibration as a function of a manual actuation of the dosing pump. When the medium from the medium reservoir is delivered into the dosing chamber by means of a dosing pump that is actuated manually, it is advantageous if, directly after actuation of the dosing pump and the associated transport of medium into the dosing chamber, a medium-dosing operation from the dosing chamber takes place by actuation of the vibration unit. In order to be able to combine these successive operations in an advantageous manner, synchronization means are provided which in particular detect an actuation of the dosing pump. From detection of said actuation, a control signal is generated which is forwarded to a control means of the vibration unit. In the control means, the control signal triggers a vibration request which, after a defined time span, triggers the vibration unit and thus leads to medium being dosed from the dosing chamber. As the detector for manual actuation of the dosing pump, it is possible in particular to use contact switches, flow meters, solenoid switches or pressure gauges. A control means for the vibration unit is in particular configured as an electrical or electronic switching circuit. With the aid of the synchronization means, it is ensured that each manual actuation of the dosing pump is followed by a synchronized dosing of medium from the dosing chamber.

Housing parts of the medium reservoir and of the energy store are advantageously made of materials from a uniform group of materials. This is especially advantageous when the energy store and the medium reservoir are combined in the separate disposable unit. The separate disposable unit preferably constitutes a separate housing unit and is discarded in one piece. At the time of disposal, the medium reservoir is in general at least almost completely empty. Thus, for easy and proper disposal of the disposable unit, the main requirement is for the energy store coupled to the medium reservoir to be disposed of in an environmentally friendly manner. Since the energy store in any case requires housing parts for encasing it, it is particularly advantageous if the materials used for this casing anyway are also used for configuring the medium reservoir and the housing unit enclosing the medium reservoir and energy store of the disposable unit. Even in cases when it is not possible to use identical materials at all points of the different constituent parts of the medium reservoir and energy store, it is at least of advantage if all the materials used belong to a single group of materials. These are, in particular, metals or plastics.

Further advantages and features will become evident from the claims and from the following description of a preferred illustrative embodiment of the invention, set out with reference to the single FIGURE.

The single FIGURE shows, in a plane sectional representation, a schematic view of a microdosing device.

A microdosing device 1 has, in a base housing 15, a solidly integrated atomizing means 16 with a control device 17. The atomizing means 16 is made up of a dosing chamber, designed as an ultrasonic chamber 4, and of a vibration unit, designed as an ultrasonic oscillator 6. The ultrasonic chamber 4 has a boundary surface designed as substrate 7, and a membrane 18 with dispensing openings designed as membrane pores 5. The ultrasonic oscillator 6 of the atomizing means 16 is supplied with electrical energy from the control device 17. The electrical energy is forwarded to the ultrasonic oscillator 6 as a function of the control signals arriving at the control device 17. In the base housing 15 there is a receiving well 19 which is provided to receive a separate disposable unit with a housing unit in the form of a cartridge 8. The cartridge 8 has an energy store designed as a battery 2 and a medium reservoir designed as a plastic tank 3. The cartridge 8 is connected to the control device 17 via an electromechanical interface by means of contact surfaces 14 and contact means designed as contact tongues 10, and it is connected via an attachment piece 20 to a dosing pump designed as a piston pump 11. The cartridge 8 is coupled in a releasable manner to the base housing 15 via locking means designed as locking lugs 9.

The receiving well 19 is closed by an actuation closure piece 21, the actuation closure piece 21 allowing an actuating movement to be applied to the cartridge 8, which thus permits triggering of a medium-dosing operation. Also arranged on the base housing 15 there is a counting and display device designed as counter 13, which is connected to the control device 17 via a control line 22. A magnet 28 for controlling a solenoid switch 27 is provided on the piston pump 11, the solenoid switch being connected to the control device 17 via a signal line 29. On the base housing 15 there is an air inflow channel 23 which is provided for delivering ambient air into a mixing area 24 of a mouthpiece 25. Provided in the air inflow channel 23 there is a dose-triggering means which is designed as a nonreturn valve 12 and which is kept in a closed position by means of a spring (not shown) and is deflected counter to the pretensioning of the spring only when the user inhales.

To dispense a dose of medium from the microdosing device 1, a user (not shown) exerts a force which is applied to the actuation closure piece 21 in operating direction 26. To do so, the user's index finger in particular is placed on the actuation closure piece 21. The microdosing device 1 is supported on an underside of the base housing 15 by the user's thumb. By applying the actuating force, the actuation closure piece 21 is displaced and thus permits transfer of the actuating force to the cartridge 8. The cartridge 8, which comprises the battery 2 and the plastic tank 3, is likewise displaced in operating direction 26 by the actuating force and leads to the generation of a pump movement in the piston pump 11. Almost at the same time as the actuating force is applied, the user begins an inhalation process, for which purpose he places the mouthpiece 25 firmly between his lips and sucks air through the air inflow channel 23. By means of this sucking-in of air, the nonreturn valve 12 provided in the air inflow channel 23 is deflected from a rest position and thus sends an electrical trigger signal to the control device 17.

With at least almost simultaneous occurrence of the trigger signal and a synchronization signal triggered by the piston pump, which is generated by the solenoid switch 27 and the magnet 28 arranged on the piston pump, the ultrasonic oscillator 6 is activated. Since at the same time, by actuation of the piston pump 11, the ultrasonic chamber 4 is filled with medium from the plastic tank 3 via a medium line 30, the oscillations of the ultrasonic oscillator 6 create a pressure wave in the medium. The pressure wave means that a flow resistance of the membrane pores 5 of the membrane 18 is overcome, as a result of which the medium is dispensed in the form of fine droplets into the mixing area 24. Since, at the same time as this dispensing of medium, a stream of air generated by the inhalation process is present in the mixing area 24, the dispensed medium mixes thoroughly with the stream of air. The dispensed medium and the stream of air can therefore be inhaled through the mouthpiece 25 by the user and be carried onwards into the pharynx, bronchi and/or lungs of the user. At the same time, when the actuation closure piece 21 is activated, the counter 13 is triggered via the control line 22, as a result of which a displayed numerical value is changed.

1. Microdosing device (1) for a medium, with an energy store (2) for electrical energy, a medium reservoir (3), and a dosing chamber (4) which at least temporarily receives a quantity of liquid and to which at least one dispensing opening (5) and one vibration unit (6) are assigned, said vibration unit (6) being operatively connected at least to one boundary surface (7) of the dosing chamber (4) in order to cause this boundary surface (7) to oscillate for the purpose of a dispensing operation, characterized in that a quantity of energy stored in the energy store (2) and an energy demand required to dispense a quantity of medium stored in the medium reservoir (3) correspond at least almost to one another.

2. Microdosing device according to claim 1, characterized in that the energy store (2) and the medium reservoir (3) are combined in a separate disposable unit (8).

3. Microdosing device according to claim 2, characterized in that the disposable unit (8) is connected in a releasable manner to a housing of the microdosing device.

4. Microdosing device according to one of the preceding claims, characterized in that a dosing pump (11) to be actuated manually is provided on the medium reservoir (3).

5. Microdosing device according to one of the preceding claims, characterized in that a mechanical and/or electrical dose-triggering means (12) is provided to synchronize the dosing with a respiratory movement on the part of a user.

6. Microdosing device according to one of the preceding claims, characterized in that a mechanical and/or electronic dosing-locking means is provided to ensure correct dosing of the medium.

7. Microdosing device according to one of the preceding claims, characterized in that a counting and/or display device (13) is provided for documenting the dispensed doses of medium.

8. Microdosing device according to one of claims 4 to 8, characterized in that synchronization means (27, 28) are provided for a timed vibration as a function of a manual activation of the dosing pump (11).
